(19) United States
(12) Patent Application Publication
(10) Pub. No.: US 2024/0427626 A1
(43) Pub. Date: Dec. 26, 2024

(54) Universal flash storage system including host command queue for the virtual machine environment

(71) Applicant: MEDIATEK INC., Hsin-chu (TW)

(72) Inventors: Liang-Yen Wang, Hsinchu City (TW); Chih-Chieh Chou, Hsinchu City (TW); Chin-Chin Cheng, Hsinchu City (TW)

(73) Assignee: MEDIATEK INC., Hsin-chu (TW)

(21) Appl. No.: 18/752,830

(22) Filed: Jun. 25, 2024

Related U.S. Application Data
(60) Provisional application No. 63/510,155, filed on Jun. 26, 2023.

(51) Int. Cl. G06F 9/455; G06F 3/06

(52) U.S. Cl. CPC G06F 9/45558; G06F 3/0619; G06F 3/0659; G06F 3/0679; G06F 2009/45579; G06F 2009/45587

(57) ABSTRACT

A system includes a host, a storage host controller, and a storage device. The host includes a hypervisor for running a first virtual machine and a second virtual machine. The storage host controller includes a plurality of first multi-circular queues (MCQs) assigned to the first virtual machine and a plurality of second MCQs assigned to the second virtual machine. The plurality of first MCQs assigned to the first virtual machine is used to control operations of the first virtual machine. The plurality of second MCQs assigned to the second virtual machine is used to control operations of the second virtual machine. The storage device has a first portion linked to the first virtual machine for being accessed by the first virtual machine, and a second portion linked to the second virtual machine for being accessed by the second virtual machine wherein the first portion and the second portion are isolated.

### CROSS REFERENCE TO RELATED APPLICATIONS

This application claims the benefit of U.S. Provisional Application No. 63/510,155, filed on Jun. 26, 2023. The content of the application is incorporated herein by reference.

### BACKGROUND

Universal Flash Storage (UFS) is a flash storage specification designed for digital cameras, mobile phones, and other consumer electronic devices. The goal of UFS is to provide higher data transfer speeds and increased reliability compared to other flash memory storage formats.

A virtual machine (VM) is like any other computer, complete with a CPU, memory, and storage. However, instead of being a physical device, a VM exists as software code. It runs within a window on the computer or server, separate from the host system. VMs are used for various purposes, such as testing new operating systems, running legacy applications, and creating isolated environments. They offer benefits like cost savings and portability.

Virtualization enables multiple virtual machines to run on a single physical machine, optimizing resource utilization and improving efficiency. Each virtual machine operates independently and remains isolated from other VMs and the host computer. VMs play a crucial role in server environments by centralizing workloads and enhancing the efficiency of resource use.

### SUMMARY

An embodiment provides a system. The system includes a host, a storage host controller, and a storage device. The host includes a hypervisor for running a first virtual machine and a second virtual machine. The storage host controller includes a plurality of first multi-circular queues (MCQs) assigned to the first virtual machine and a plurality of second MCQs assigned to the second virtual machine. The plurality of first MCQs assigned to the first virtual machine is used to control operations of the first virtual machine. The plurality of second MCQs assigned to the second virtual machine is used to control operations of the second virtual machine. The storage device has a first portion linked to the first virtual machine for being accessed by the first virtual machine, and a second portion linked to the second virtual machine for being accessed by the second virtual machine. The first portion and the second portion are isolated.

An embodiment provides a method for isolating a shared storage device for a first virtual machine and a second virtual machine. The method includes initiating a first request, by the first virtual machine, with a first identifier; initiating a second request, by the second virtual machine, with a second identifier; assigning a plurality of first multi-circular queues (MCQs) for the first virtual machine and a plurality of second MCQs for the second virtual machine; and isolating a first portion and a second portion in a storage device for the first virtual machine and the second virtual machine respectively according to the first identifier and the second identifier. The first portion and the second portion are not overlapped.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a universal flash storage (UFS) system according to an embodiment of the present invention.

FIG. 2 is a schematic diagram of a UFS system according to another embodiment of the present invention.

FIG. 3 is a schematic diagram of a UFS system according to another embodiment of the present invention.

FIG. 4 is a flowchart of a method for isolating a shared storage device for a first virtual machine and a second virtual machine.

### DETAILED DESCRIPTION

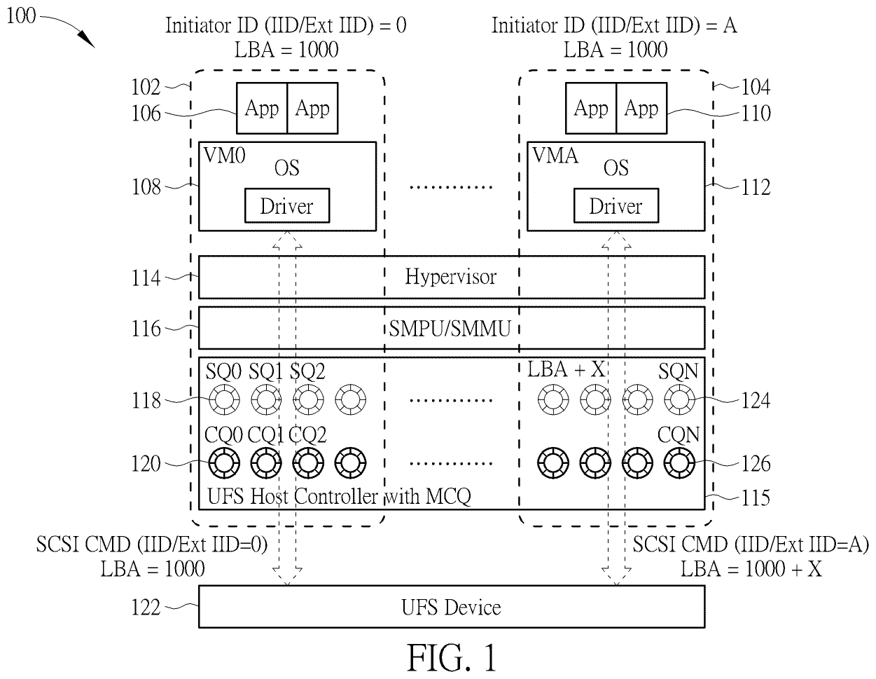

FIG. 1 is a schematic diagram of a universal flash storage (UFS) system 100 according to an embodiment of the present invention. The UFS system 100 includes a hypervisor 114 and a system memory processing unit (SMPU)/system memory management unit (SMMU) 116 for running a first virtual machine 102 and a second virtual machine 104. The first virtual machine 102 includes a first operation system (OS) 108 with drivers and first applications 106. The second virtual machine 104 includes a second OS 112 with drivers and second applications 110. The UFS system 100 further includes a UFS host controller 115 with a plurality of multi-circular queues (MCQs). The UFS system 100 is not limited thereto, it can be other systems. The UFS host controller 115 can be a storage host controller other than the UFS host controller.

In an embodiment, the plurality of multi-circular queues (MCQs) comprises first multi-circular queues (MCQs) assigned to the first virtual machine 102 and a plurality of second MCQs assigned to the second virtual machine 104. Each of the MCQs comprises a submission queue (SQ) or a completion queue (CQ). In some embodiment, each of the MCQs may comprise a plurality of SQs and CQs. The plurality of first MCQs include first SQs 118 and first CQs 120 assigned to the first virtual machine 102. The plurality of second MCQs include second SQs 124 and second CQs 126 assigned to the second virtual machine 104. The SQs 118, 124 are used for sending requests, and the CQs 120, 126 are used for receiving responses from the UFS device 122.

During operation, the first virtual machine 102 initiates a first request with a first initiator ID (IID) and a first logical block addressing and the second virtual machine initiates a second request with a second initiator ID and a second logical block addressing. In some case, the value of the first logical block addressing and that of the second logical block addressing may be the same. The first request and the second request may access the same logical block addressing in a storage device such as a UFS device 122 and it would cause the data to be overwritten. To avoid this situation, the UFS controller 115 may assign a first offset to the first logical block addressing and a second offset to the second logical block addressing when accessing to the UFS device 122. The first offset is different from the second offset to ensure a first portion of the UFS device 122 to be accessed by the first request corresponding to the first virtual machine 102 would be different from a second portion of the UFS device to be accessed by the second request corresponding to the second virtual machine 104.

Therefore, the first portion of a UFS device 122 is linked to the first virtual machine 102 for being accessed by the first virtual machine 102, and the second portion of the UFS device 122 is linked to the second virtual machine 104 for being accessed by the second virtual machine 104. The data storage regions for the first virtual machine 102 and the second virtual machine 104 are isolated by using a logical block address (LBA) offset assigned by the UFS host controller 115. For example, the LBA of the first request initiated by the first virtual machine 102 is 1000, and the LBA of the second request initiated by the second virtual machine 104 is 1000 as well.

The UFS host controller 112 may assign different offsets to LBAs of the first request and the second request according to initiator identifications (IIDs) or extended initiator identifications (Ext IIDs) which are corresponding to different virtual machines. In FIG. 1, the LBA offset may be zero or a positive integer. In this case, the LBA offset to the first request is zero (0) and the LBA offset to the second request is “X”. Besides, the first virtual machine 102 is assigned with IID 0, and the second virtual machine 104 is assigned with IID A. Since the first virtual machine 102 is assigned with IID 0 and the second virtual machine 104 is assigned with IID A, each of the first MCQs inherits the IID 0, and each of the second MCQs inherits the IID A for distinguishing and protecting the first virtual machine 102 and the second virtual machine 104. The first virtual machine 102 and the second virtual machine 104 communicate with the UFS device 122 through the first MCQs and the second MCQs respectively. Therefore, small computer system interface (SCSI) commands with IID 0 and IID A from the first virtual machine 102 and the second virtual machine 104 could pass through the hypervisor 114 and the UFS host controller 115 without mediation. This enables drivers in the OSs 108, 112 to directly access the UFS device 122 through the SCSI commands. In the embodiment, the number of virtual machines is not limited to 2, but can be any positive integer greater than 1.

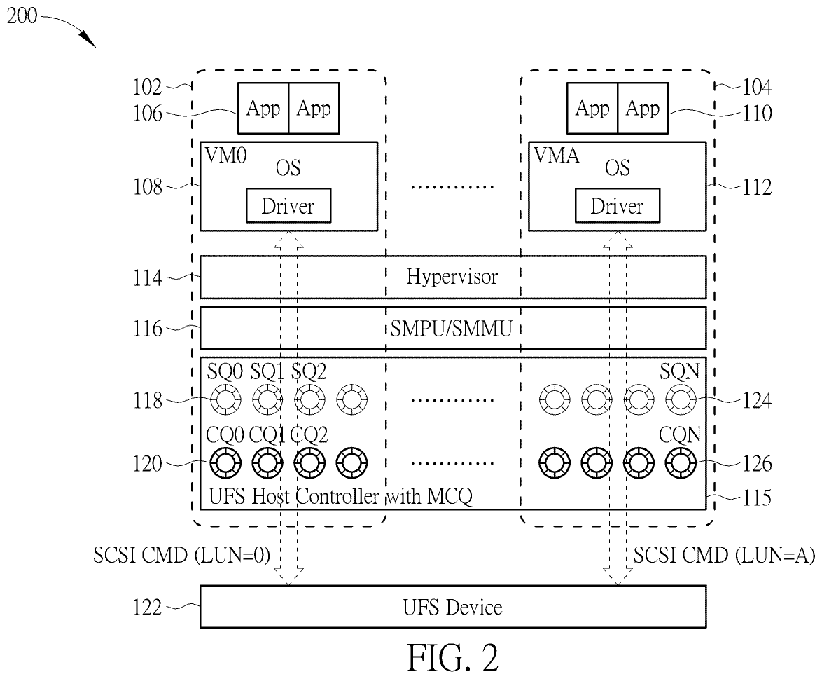

FIG. 2 is a schematic diagram of a UFS system 200 according to another embodiment of the present invention. The UFS system 200 includes a hypervisor 114 and a system memory processing unit (SMPU)/system memory management unit (SMMU) 116 for running a first virtual machine 102 and a second virtual machine 104. The first virtual machine 102 includes a first operation system (OS) 108 with drivers and first applications 106. The second virtual machine 104 includes a second OS 112 with drivers and second applications 110. The UFS system 200 further includes a UFS host controller 115 with a plurality of multi-circular queues (MCQs). The UFS system 200 is not limited thereto, it can be other systems. The UFS host controller 115 can be a storage host controller other than the UFS host controller.

In an embodiment, the plurality of multi-circular queues (MCQs) comprises first multi-circular queues (MCQs) assigned to the first virtual machine 102 and a plurality of second MCQs assigned to the second virtual machine 104. Each of the MCQs comprises a submission queue (SQ) or a completion queue (CQ).). In some embodiment, each of the MCQs may comprise a plurality of SQs and CQs. The plurality of first MCQs include first SQs 118 and first CQs 120 assigned to the first virtual machine 102. The plurality of second MCQs include second SQs 124 and second CQs 126 assigned to the second virtual machine 104. The SQs 118, 124 are used for sending requests, and the CQs 120, 126 are used for receiving responses from the UFS device 122.

During operation, the first virtual machine 102 initiates a first request with a first logical unit number (LUN) and a first logical block addressing and the second virtual machine initiates a second request with a second LUN and a second logical block addressing. In some case, the value of the first logical block addressing and that of the second logical block addressing may be the same. The first request and the second request may access the same logical block addressing in a storage device such as a UFS device 122 and it would cause the data to be overwritten. To avoid this situation, the UFS controller 115 may assign a first offset to the first logical block addressing and a second offset to the second logical block addressing when accessing to the UFS device 122. The first offset is different from the second offset to ensure a first portion of the UFS device 122 to be accessed by the first request corresponding to the first virtual machine 102 would be different from a second portion of the UFS device to be accessed by the second request corresponding to the second virtual machine 104.

A first portion of a UFS device 122 is linked to the first virtual machine 102 for being accessed by the first virtual machine 102, and a second portion of the UFS device 122 is linked to the second virtual machine 104 for being accessed by the second virtual machine 104. In an embodiment, a logical unit number (LUN) is assigned to each request initiated by each virtual machine by the host, to be specific, by the hypervisor 114. The logical unit number (LUN) is an identifier used in storage systems to distinguish between different logical units (such partitions) that are part of a storage device. By using different LUNs of the requests initiated by the virtual machines, the system make sure a first portion and a second portion of the UFS device 122 are isolated. In FIG. 2, for example, the request from the first virtual machine 102 is assigned with LUN 0, and the second request from the second virtual machine 104 is assigned with LUN A. Each of the first MCQs inherits the LUN 0, and each of the second MCQs inherits the LUN A for distinguishing and protecting the first virtual machine 102 and the second virtual machine 104. The first virtual machine 102 and the second virtual machine 104 communicate with the UFS device 122 through the first MCQs and the second MCQs respectively. Therefore, SCSI commands with LUN 0 and LUN A from the first virtual machine 102 and the second virtual machine 104 could pass through the hypervisor 114 and the UFS host controller 115 without mediation. This enables drivers in the OSs 108, 112 to directly access the UFS device 122 through the SCSI commands. In the embodiment, the number of virtual machines is not limited to 2, but can be any positive integer greater than 1.

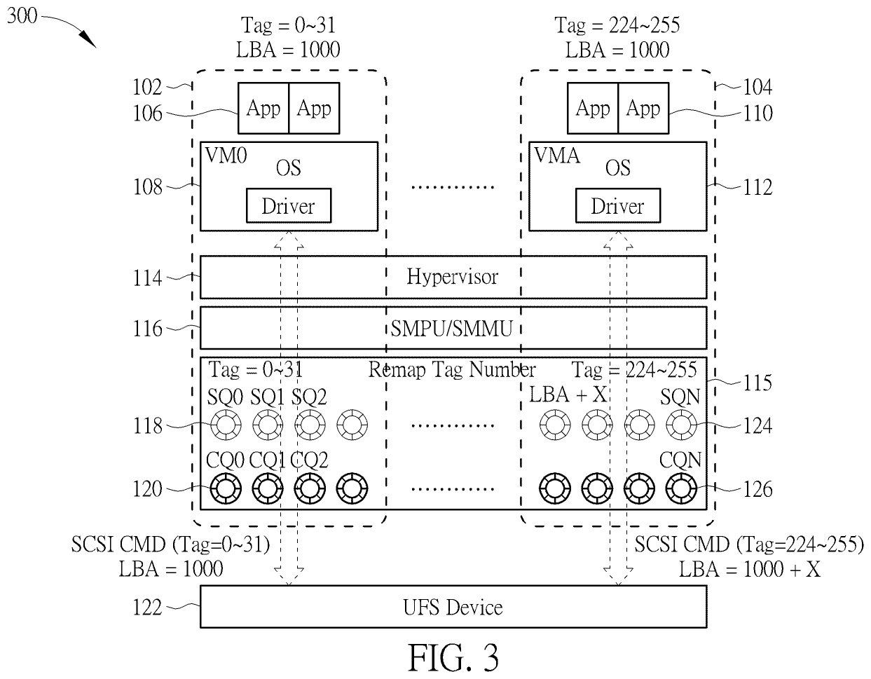

FIG. 3 is a schematic diagram of a UFS system 300 according to another embodiment of the present invention. The UFS system 300 includes a hypervisor 114 and a system memory processing unit (SMPU)/system memory management unit (SMMU) 116 for running a first virtual machine 102 and a second virtual machine 104. The first virtual machine 102 includes a first operation system (OS) 108 with drivers and first applications 106. The second virtual machine 104 includes a second OS 112 with drivers and second applications 110. The UFS system 300 further includes a UFS host controller 115 with a plurality of multi-circular queues (MCQs). The UFS system 300 is not limited thereto, it can be other systems. The UFS host controller 115 can be a storage host controller other than the UFS host controller.

In an embodiment, the plurality of multi-circular queues (MCQs) comprises first multi-circular queues (MCQs) assigned to the first virtual machine 102 for controlling operations of the first virtual machine 102 and a plurality of second MCQs assigned to the second virtual machine 104 for controlling operations of the second virtual machine 104. Each of the MCQs includes a submission queue (SQ) or a completion queue (CQ). The plurality of first MCQs include first SQs 118 and first CQs 120 assigned to the first virtual machine 102. The plurality of second MCQs include second SQs 124 and second CQs 126 assigned to the second virtual machine 104. The SQs 118, 124 are used for sending requests, and the CQs 120, 126 are used for receiving responses from the UFS device 122.

During operation, the first virtual machine 102 initiates a first request with a first tag number and a first logical block addressing and the second virtual machine initiates a second request with a second tag number and a second logical block addressing. In some case, the value of the first logical block addressing and that of the second logical block addressing may be the same. The first request and the second request may access the same logical block addressing in a storage device such as a UFS device 122 and it would cause the data to be overwritten. To avoid this situation, the UFS controller 115 may assign a first offset to the first logical block addressing and a second offset to the second logical block addressing when accessing to the UFS device 122. The first offset is different from the second offset to ensure a first portion of the UFS device 122 to be accessed by the first request corresponding to the first virtual machine 102 would be different from a second portion of the UFS device to be accessed by the second request corresponding to the second virtual machine 104.

Therefore, the first portion of a UFS device 122 is linked to the first virtual machine 102 for being accessed by the first virtual machine 102, and the second portion of the UFS device 122 is linked to the second virtual machine 104 for being accessed by the second virtual machine 104. The data storage regions for the first virtual machine 102 and the second virtual machine 104 are isolated by using a logical block address (LBA) offset. For example, the LBA of the first request initiated by the first virtual machine 102 is 1000, and the LBA of the second request initiated by the second virtual machine 104 is 1000 as well.

The UFS host controller 112 may assign different offsets to LBAs of the first request and the second request according to sections of tag numbers which are corresponding to the virtual machines 102, 104. In FIG. 3, the LBA offset may be zero or a positive integer. In this case, the LBA offset to the first request is zero (0) and the LBA offset to the second request is “X”. Besides, the first virtual machine 102 is assigned with a section of tag numbers 0-31, and the second virtual machine 104 is assigned with a section of tag numbers 224-255. Since the first virtual machine 102 is assigned with the section of tag numbers 0-31 and the second virtual machine 104 is assigned with the section of tag numbers 224-255, each of the first MCQs has a tag number within [0,31], and each of the second MCQs has a tag number within [224,255] for distinguishing and protecting the first virtual machine 102 and the second virtual machine 104. The first virtual machine 102 and the second virtual machine 104 communicate with the UFS device 122 through the first MCQs and the second MCQs respectively. Therefore, SCSI commands with tag numbers within [0,31] and tag numbers within [224,255] from the first virtual machine 102 and the second virtual machine 104 could pass through the hypervisor 114 and the UFS host controller 115 without mediation. This enables drivers in the OSs 108, 112 to directly access the UFS device 122 through the SCSI commands. In the embodiment, the number of virtual machines is not limited to 2, but can be any positive integer greater than 1.

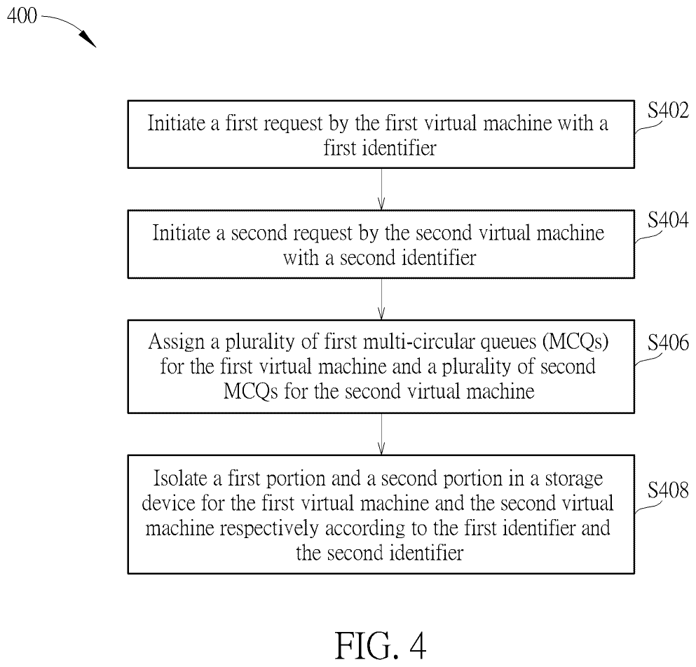

FIG. 4 is a flowchart of a method 400 for isolating a shared storage device for a first virtual machine 102 and a second virtual machine 104. The method 400 includes the following steps:
Step S402: Initiate a first request by the first virtual machine 102 with a first identifier;
Step S404: Initiate a second request by the second virtual machine 104 with a second identifier;
Step S406: Assign a plurality of first MCQs for the first virtual machine 102 and a plurality of second MCQs for the second virtual machine 104; and
Step S408: Isolate a first portion and a second portion in a storage device for the first virtual machine 102 and the second virtual machine 104 respectively according to the first identifier and the second identifier.

In step S402, the first request is initiated by the first virtual machine 102 with the first identifier. In step S404, the second request is initiated by the second virtual machine 104 with the second identifier. In an embodiment, the first identifier can be an initial identification (IID), an extended initiator identification (Ext IID), a tag number and/or a logical unit number (LUN). The second identifier can be an initial identification (IID), an extended initiator identification (Ext IID), a tag number and/or a logical unit number (LUN). In step S406, a plurality of first MCQs is assigned for the first virtual machine 102 and a plurality of second MCQs is assigned for the second virtual machine 104. In an embodiment, the first MCQs can include first SQs 118 and first CQs 120, and the second MCQs can include second SQs 124 and second CQs 126. In step S408, a first portion and a second portion are isolated in a storage device for the first virtual machine 102 and the second virtual machine 104 respectively according to the first identifier and the second identifier. The first portion and the second portion are not overlapped. The data storage regions for the first virtual machine 102 and the second virtual machine 104 are isolated by using an LBA offset. For example, the LBA of the first request initiated by the first virtual machine 102 is 1000, and the LBA of the second request initiated by the second virtual machine 104 is 1000 as well. The UFS host controller 115 may assign different offsets to LBAs of the first request and the second request according to the first identifier and the second identifier. The LBA offset may be zero or a positive integer. For example, the LBA offset for the first virtual machine is 0, and the LBA offset for the second machine is X. X is a positive integer.

In conclusion, the embodiments of the present invention provide a UFS system which uses different IIDs, LUNs, or sections of tag numbers for directly accessing the UFS device by submission queues and completion queues, thus various virtual machines can be protected and distinguished.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system comprising:
a host comprising a hypervisor configured to run a first virtual machine and a second virtual machine;
a storage host controller comprising:
a plurality of first multi-circular queues (MCQs) assigned to the first virtual machine, and configured to control operations of the first virtual machine; and
a plurality of second MCQs assigned to the second virtual machine, and configured to control operations of the second virtual machine; and
a storage device having a first portion linked to the first virtual machine for being accessed by the first virtual machine, and a second portion linked to the second virtual machine for being accessed by the second virtual machine wherein the first portion and the second portion are isolated.

2. The system of claim 1, further comprising:
a first request initiated by the first virtual machine with a first identifier, and a second request initiated by the second virtual machine with a second identifier.

3. The system of claim 2, wherein the plurality of first MCQs comprise a first submission queue and a first completion queue assigned to the first virtual machine, and the plurality of second MCQs comprise a second submission queue and a second completion queue assigned to the second virtual machine.

4. The system of claim 2, wherein the first identifier and the second identifier are at least one of an initial identification (IID), an extended initiator identification (Ext IID), and a tag number.

5. The system of claim 4, further comprising a first logical block addressing corresponding to the first request, and a second logical block addressing corresponding to the second request.

6. The system of claim 5, further comprising a first offset assigned, by the storage host controller, to the first logical block addressing for logical block addressing in the storage device and a second offset assigned, by the storage host controller, to the second logical block addressing for logical block addressing in the storage device, wherein the first offset and the second offset are different.

7. The system of claim 2, wherein the first identifier and the second identifier are logical unit numbers.

8. The system of claim 7, wherein the logical unit numbers are assigned by the host corresponding to the first request and the second request.

9. A method for isolating a shared storage device for a first virtual machine and a second virtual machine, comprising:
initiating a first request, by the first virtual machine, with a first identifier;
initiating a second request, by the second virtual machine, with a second identifier;
assigning a plurality of first multi-circular queues (MCQs) for the first virtual machine and a plurality of second MCQs for the second virtual machine; and
isolating a first portion and a second portion in a storage device for the first virtual machine and the second virtual machine respectively according to the first identifier and the second identifier, wherein the first portion and the second portion are not overlapped.

10. The method of claim 9, wherein the plurality of first MCQs comprise a first submission queue and a first completion queue assigned to the first virtual machine, and the plurality of second MCQs comprise a second submission queue and a second completion queue assigned to the second virtual machine.

11. The method of claim 9, wherein the first identifier and the second identifier are at least one of an initiator identification (IID), an extended initiator identification (Ext IID), and a tag number.

12. The method of claim 11, further comprising assigning a first logical block addressing corresponding to the first request, and a second logical block addressing corresponding to the second request when initiating the first request and the second request.

13. The method of claim 12, further comprising assigning a first offset to the first logical block addressing for accessing the storage device for the first request; and assigning a second offset to the second logical block addressing for accessing the storage device for the second request, wherein the first offset and the second offset are different.

14. The method of claim 9, wherein the first identifier and the second identifier are logical unit numbers.

15. The system of claim 14, wherein the logical unit numbers are assigned by the host corresponding to the first request and the second request.
